(19) United States
(12) Patent Application Publication
(10) Pub. No.: US 2006/0219068 A1
(43) Pub. Date: Oct. 5, 2006

(54) Tool support for lathes

(75) Inventor: Baudouin Ernest Uebelhart, Oberdorf (CH)

Correspondence Address: BREINER & BREINER, L.L.C., P.O. BOX 19290, ALEXANDRIA, VA, 22320-0290, US

(73) Assignee: Microswiss Technologies AG, Oensingen (CH)

(21) Appl. No.: 10/566,260

(22) PCT Filed: Jul. 30, 2004
(86) PCT No.: PCT/CH04/00479

§ 371 Date: Mar. 21, 2006

(30) Foreign Application Priority Data
Jul. 31, 2003 (WO) PCT/CH03/00526

(51) Int. Cl. B23B 29/00

(52) U.S. Cl. 82/158

(57) ABSTRACT

The tool support comprises a basic structure (8;108) on which a slide (5;105) is movable in a controlled manner transversely to the spindle axis (7;107), two tool holders (6) being mounted on said slide (5;105) which are displaceable parallel to each other and serving to hold different tools (9,9′;109,109′), said holders (6,6′;107,107′) being selectively displaceable in the direction of the spindle axis (7;107) or away from that axis through an angle of 90° with respect to the direction of movement of the slide (5;105), and further comprising driving means (1,2,3,3′;100,102,106,106′,103) to displace the slide (5;105) and the tool holders (6,6′;107,107′) along their axis of movement (Y,Z) into a predetermined working position.

The present invention relates to a tool support provided for working a work piece at the working spindle of a lathe.

Tool supports for tools to be mounted on the working spindle of a lathe are known and serve for machining work pieces of any kind of material. Depending on the work to be performed, the appropriate tools have to be chosen and to be mounted at the tool support. An operation, which often is very time consuming (secondary processing time). In order to avoid this very complicated and complex turret heads with different tools are used.

An object of the present invention was to elaborate a tool support which provides highest precision with a very simple construction and which reduces the secondary processing time (re-tooling) practically to zero.

This object is achieved with a tool support of the type defined herein above according to the present invention having the features of the characterizing part of claim 1.

Particularly advantageous embodiments of the invention are defined in the depending claims.

According to this invention, the tool support enables to hold two different tools and to selectively use them, keeping the cost of the constructive elements of the support and their number at the minimum, particularly if for moving the components of this support a single motor is used having a driving shaft for displacing the slide and also selectively the desired tool support, this by the intermediary of a lever with an inner control curve or two cam discs, this e.g. by means of a lever having an innercam surface and two cam disks or by means of two control cam curves for the two tool holders (cutting-off slide), an intermediary gear and a control cam curve for the slide (transverse slide).

The enforced sequence of movement is made in a controlled manner, sequencially or simultaneously along the trajectory axis X and Y or by a translatory path. This ensures that the secondary processing time for the selection of the tool is reduced to a minimum.

In order to carry out complicated working steps it is possible to arrange several tool supports at the spindle (each with two different tools), preferably with angular spaces of 120°, which excludes on the one hand the risk of collision with a neighbouring tool and on the other hand reduces the secondary processing time for the tools selection practically to zero.

Thanks to this surprising concept the productivity of a lathe can be substantially increased, keeping the cost at a low level.

If the tool supports are mounted on a longitudinally movable slide (tool slide), it is possible to enlarge the use of each double tool additionally in a further working plane (along the Z-axis).

The invention will be herein after described in more detail on the basis of embodiments and sequences of movement represented in the drawing. In the drawings:

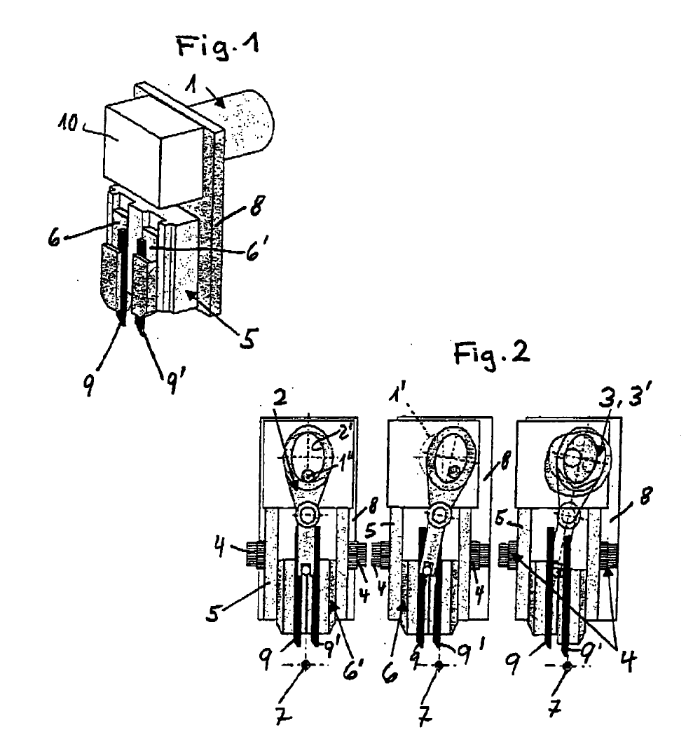

FIG. 1 represents schematically essential components of a tool support in accordance with the invention;

FIG. 2 shows a tool support according to the invention having particularly advantageous driving means, shows in three different positions with regard to the spindle;

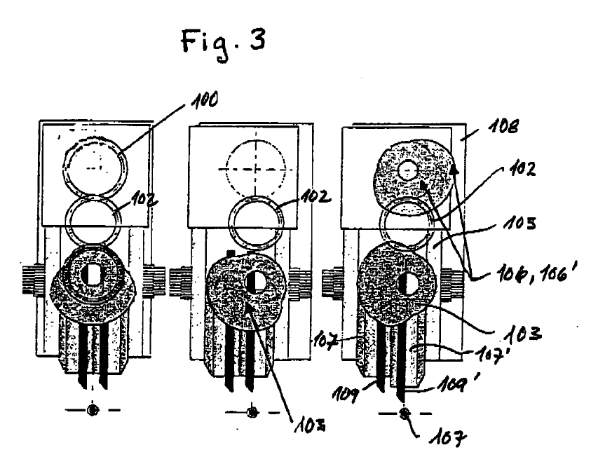

FIG. 3 represents a variant of the tool support of FIG. 2.

FIG. 1 of the drawing shows purely schematically a tool support in accordance with the invention, having a central driving motor 1, a basic structure 8, or which a laterally displaceable slide 5 with two tool holders 6,6′ is arranged. Different tools 9,9′ are hold in the holders 6,6′. Behind the cover 10 which is connected with the slide 5 and which is displaceable is arranged the proper drive of the control elements 2 and 3,3′ (see FIG. 2).

The basic plate 8 is usually mounted on a Z-slide (not represented), thus allowing an additional controlled movement in Z-direction (along the spindle).

Due to the additional Z-movements further simultaneous working operations are possible which permit particularly for turning automats a massive increase of productivity.

FIG. 2 illustrates schematically the operation principle of the double or twin tool support:

Motor 1 drives by the intermediary of shaft 1′ the control elements, namely lever 2 and cam 3. The lever 2 with inner curve 2′ surves to displace the slide 5 in transverse direction (Y) until reaching adjustable stops 4 (e.g. looking screws), such limitation of the displacement path serving to bring the tools 9,9′ into their middle position (FIG. 2 outside left). The two cams 3,3′ serve to bring the desired tool onto the working diameter (in X-direction).

The shifting in Y-direction can be performed as shown by means of lever 2 (up to the desired stop, if the motor shaft continues to rotate the follower element of the inner curve of the inner curve of the lever is further advanced against a spring force, whilst the slide is stopped), or a separate drive with a measuring system can be used (attacking e.g. on the longitudinal side of the slide).

FIG. 2 further shows that after adjusting the middle position of the slide 5 (left side) the stop for the right side tool 9′ is approached (middle) and thereafter the tool 9′ is moved over the one cam 3′ into its working position in direction of the spindle 7.

The feed of the tools 9,9′ by means of the corresponding cams 3,3′ is carried out by the attack of the cams on an extension of the tool holders 6,6′. The latter are moved against a resetting force (spring, not represented), such that any tool which is not being controlled by the cam remains always out of its working position. The motor shaft 1′, departing from the middle position, can be rotated in both directions up to 180°.

As already mentioned, it is possible to arrange a plurality of tool supports around a spindle whereby the described advantages can be used in multiple manners. The increase in performance allows to replace the curve-controlled turning automats which up to now where held as “irreplaceable”.

FIG. 3 represents a variant of the tool support according to FIG. 2, in which the control lever (FIG. 2) is replaced by an intermediary gear 102 and a control cam curve 103 (driven by the driving wheel 100) for the slide 105 (transverse slide). This ensures that the slide 105 can move into the desired working position. The use of the intermediary gear 102 allows to provide a single driving motor for both axial movements. The control cam curve 103 controls the transverse slide 105 and the two upper control cam curves 106,106′ the tool holders 107, 107′ of the two tools 109,109′.

1. A tool support provided for machining a work piece on the working spindle of a lathe, characterized by
a basic structure;
a slide mounted on hat basic structure which is displaceable in a controlled manner transversly to the spindle axis along an axis (Y);
two tool holders mounted parallely to each other on that slide for holding different tools, that holders being displaceable in an angle 90° with respect to the direction of movement of the slide individually or selectively with respect to the spindle axis along an axis (X) into the working position and out of this working position and out of this working position respectively, and
driving means for displacing the slide and the tool holders sequentially or simultaneously along their axis of movement (Y resp. X) into a predetermined working position.

2. Tool supporting according to claim. 1, characterized in that said basic structure is adjustable along an axis (Z) which is parallel to said spindle axis.

3. Tool support according to claim 2, characterized in that said basic structure can be mounted on a tool slide which is displaceable along said spindle axis.

4. Tool support according to any of claims 1 to 3, characterized in that said tool holders are movable into their working position against a resetting force, e.g. against a spring force.

5. Tool support according to any of claims 1 to 3, characterized in that said driving means comprise a common motor having a driving shaft for a driving wheel (100), the latter driving an intermediary gear (102) which in twin driving a control cam curve (103) for the transverse slide (105) and/or two further control cam curves (106,106′) for the tool holders (107,107′).

6. A lathe equipped with tool supports according to any of claims 1 to 4, characterized in that a plurality of tool supports is arranged around the working, spindle, preferable in a star-shaped configuration with angular distance of 120°, each tool support having its own driving means for its displaceable components.
